(19) United States
(12) Patent Application Publication
(10) Pub. No.: US 2007/0217131 A1
(43) Pub. Date: Sep. 20, 2007

(54) SYSTEMS AND METHODS FOR PROVIDING A MOVABLE COMPUTER DISPLAY

(76) Inventor: Garry Kehr, Seattle, WA (US)

Correspondence Address: RUTTLER LAW LLC, 1122 EAST PIKE STREET, # 1131, SEATTLE, WA, 98122, US

(21) Appl. No.: 11/308,296

(22) Filed: Mar. 15, 2006

(51) Int. Cl. G06F 1/16

(52) U.S. Cl. 361/681; 248/917

(57) ABSTRACT

This invention relates generally to computer displays, and more specifically, to systems and methods for providing a movable laptop computer display. In one embodiment, the invention includes a system having a display, the display having a first hinge; a computer, the computer having a second hinge; a member, the member having a first and second end, the first end being coupled to the first hinge and the second end being coupled to the second hinge. In a further embodiment, the first hinge is configured to permit the display to tilt relative to the computer. In yet another embodiment, the second hinge is configured to permit the display to fold and swivel relative to the computer. In an additional embodiment, the display has a back portion and the first hinge is centrally coupled to the back portion.

### FIELD OF THE INVENTION

This invention relates generally to computer displays, and more specifically, to systems and methods for providing a movable laptop computer display.

### BACKGROUND OF THE INVENTION

Computers generally include a display, and in the case of laptops, the display is traditionally hingedly attached to the top rear of the laptop. In this manner, the display is capable of folding forward and backward to achieve at least two purposes. First, the folding permits the display to be stored in a convenient and safe position over the keyboard when the laptop is not in use. Second, the folding permits the display to adjust at limited angles to accommodate viewing by a laptop user.

Modern technology advances have changed display capabilities. Traditional displays merely provided visual feedback to a user for input obtained through a keyboard or mouse. Thus, when a user typed or moved a mouse, results could be perceived immediately on a display. Modern displays are further capable of accepting user input directly through touch. Thus, a user can provide or manipulate data simply by making physical contact with a display. Despite capabilities of being able to accept user input through touch in, addition to providing feedback, laptop displays have generally persisted in being hingedly attached at the top rear in a traditional manner. While a traditional hingedly attached display is somewhat accommodating for feedback and display purposes, it suffers from many limitations for user input purposes. For example, inability to provide sufficient touch resistance, to act conveniently as a writing instrument, and to permit collaborative uses are a few of the limitations.

Popularity of laptops has grown exponentially over the past two of decades. Many individuals spend most of their working hours, and a good deal of their leisure hours, using a laptop for both pleasure and utility. The dependence on laptops has led to concerns of eyesight, hand, back and other related health concerns. For instance, laptop displays are relatively small, requiring certain users to lean forward to effectively work. A forward position places stress on a user's back and extends a user's elbows laterally, which places strain on a user's wrists. Further, looking at a laptop display requires certain users to tilt their head downward, which places strain on a user's neck. Over time the repetitive stress of using a laptop can lead to more serious and chronic health problems. Despite these and other health concerns, laptop displays have generally persisted in being hingedly attached at the top rear in a traditional manner.

The mobility of laptops has permitted computer use throughout the day in various locations. For instance, laptops are often used on planes, subway cars, or automobiles. Such locations offer limited amounts of workspace, often further constrained by the seat in front of the user, which is typically reclined or tilted. On a plane, for example, workspace is severely limited when a person in a next row tilts her seat back. In this scenario, a laptop user is required to discontinue work or shift the entire laptop to an inconvenient position. Despite common usage of laptops in space constrained areas, laptop displays have generally persisted in being hingedly attached at the top rear in a traditional manner.

Although desirable results have been achieved, there is room for substantial improvement. What is needed then are systems and methods for providing a movable laptop computer display.

### SUMMARY OF THE INVENTION

This invention relates generally to computer displays, and more specifically, to systems and methods for providing a movable laptop computer display. In one embodiment, the invention includes a system having a display, the display having a first hinge; a computer, the computer having a second hinge; a member, the member having a first and second end, the first end being coupled to the first hinge and the second end being coupled to the second hinge. In a further embodiment, the first hinge is configured to permit the display to tilt relative to the computer. In yet another embodiment, the second hinge is configured to permit the display to fold and swivel relative to the computer. In an additional embodiment, the display has a back portion and the first hinge is centrally coupled to the back portion.

### BRIEF DESCRIPTION OF THE DRAWINGS

Embodiments of the present invention are described in detail below with reference to the following drawings:

FIG. 1 is side elevational view of a movable laptop computer display system, in accordance with an embodiment of the invention;

FIG. 2 is a perspective view of a movable laptop computer display system, in accordance with an embodiment of the invention;

FIG. 3 is a side elevational view of a movable laptop computer display system, in accordance with an embodiment of the invention; and

FIG. 4 is side elevational view of a movable laptop computer display system, in accordance with an embodiment of the invention.

### DETAILED DESCRIPTION

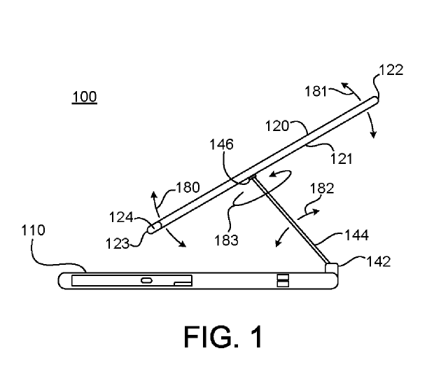

This invention relates generally to computer displays, and more specifically, to systems and methods for providing a movable laptop computer display. Specific details of certain embodiments of the invention are set forth in the following description and in FIGS. 1-4 to provide a thorough understanding of such embodiments. The present invention may have additional embodiments, or may be practiced without one or more of the details described for any particular described embodiment.

FIG. 1 is side elevational view of a movable laptop computer display system 100, in accordance with an embodiment of the invention. In one embodiment, the movable laptop computer display system 100 includes a computer 110, a hinge 142, a member 144, a hinge 146, a and a display 124. The display 124 includes a bottom 123, a top 122, a front 120, and a rear 121 portions.

In one embodiment, the computer 110 is coupled to the display 124 by the member 144. The member 144 is hingedly coupled to the computer 110 by the hinge 142 and the member 144 is hingedly coupled to the display 124 by the hinge 146. The hinge 142 is configured to permit a folding motion 182 and a swiveling motion 183. The hinge 146 is configured to permit a tilting motion 180 and 181. In one particular embodiment, the hinge 142 is as described in U.S. Pat. No. 6,587,333 or U.S. Pat. No. 5,335,142. In this regard, a movable laptop computer display is provided whereby the display 124 is configurable to fold, swivel, and tilt relative to the computer 110.

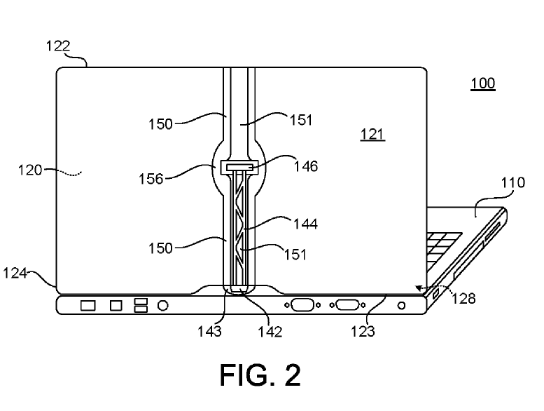

FIG. 2 is a perspective view of the movable laptop computer display system 100, in accordance with an embodiment of the invention. In one embodiment, the movable laptop computer display system 100 includes the computer 110, the hinge 142, the member 144, the hinge 146, and the display 124. The display 124 includes the front 120, the rear 121, the top 122, and the bottom 123 portions. The display 124 includes a channel 150 imbedded along the rear 121 of the display 124. The channel includes a cavity 151 and a middle portion 156.

In one embodiment, the computer 110 is coupled to the display 124 by the member 144, the member also providing for electrical communication between the computer 110 and the display 124. The member 144 is coupled to the computer 110 by the hinge 142 and the member 144 is coupled to the display 124 by the hinge 146. The hinge 142 is centrally located at the top rear of the computer 110 and is coupled to the computer 110 by hinge mount 143. The hinge 142 is configured to permit folding and swiveling motions as described in relation to FIG. 1. The hinge 146 is centrally located on the rear portion 121of the display 124 within the channel 150. The hinge 146 is configured to permit tilting motion as described in relation to FIG. 1.

In one particular embodiment, the channel 150 is a rubber type material that is imbedded within the rear portion 121of the display 124. The channel 150 extends between the top 122 and bottom 123 portions of the display 124. The channel 150 includes a cavity 151that permits the member 144 to reside within the channel 150 and be relatively flush with the rear 121 surface of the display 124. The cavity 151 extends between the top 122 and the bottom 123 portions of the display 124, thereby permitting full tilting motion of the display 124. The walls of the cavity 151 provide friction between the channel 150 and the member 144 to prevent undesired movement of the member 144.

Thus, in various embodiments, the display 124 is configurable to fold, swivel, or tilt relative to the computer 110 as described in relation to FIG. 1. The folding motion 182 permits the display 124 to partially or fully collapse over the computer 110. The swiveling motion 183 permits the display 124 to spin around an axis defined by the member 144 relative to the computer 110. The tilting motion 180 and 181 permit the display 124 to translate relative to the member 144, such that the bottom portion 123 of the display 124 can be moved away from the member 144 and the top portion 122 of the display 124 can be moved towards the member 144 and vice versa. In one particular embodiment, a friction locking mechanism 128 is provided to prevent undesired tilting motion 180 and 181.

Various alternative embodiments or variations of embodiments are possible. For instance, the computer 110 or the display 124 may be any type of computing device or monitor type or size, respectively. Further, partial or complete limits may be placed on any of the folding 182, the swiveling 183, or the tilting 180, 181 motions. Alternatively, additional motions may be permitted such as sliding the display 124 laterally relative to the computer 110 or swiveling the display 124 relative to the member 144. Additionally, the member 144 and the channel 150 may be angled along the rear portion 121 of the display 124 rather than being linear or may conform to various other shapes. Further, any of the hinge 146 or the hinge 142 may be alternatively placed along the rear portion 121 of the display 124 or the computer 110, respectively. Also, the materials used, such as that for the channel 150 or the member 144 may changed to include plastics, metals, wood, glass, combinations or other materials. Further, the member 144 may include single or multiple components. Additionally, the cavity 151 may be partial or eliminated in whole or in part. The various embodiments here are merely examples as many other embodiments can be appreciated.

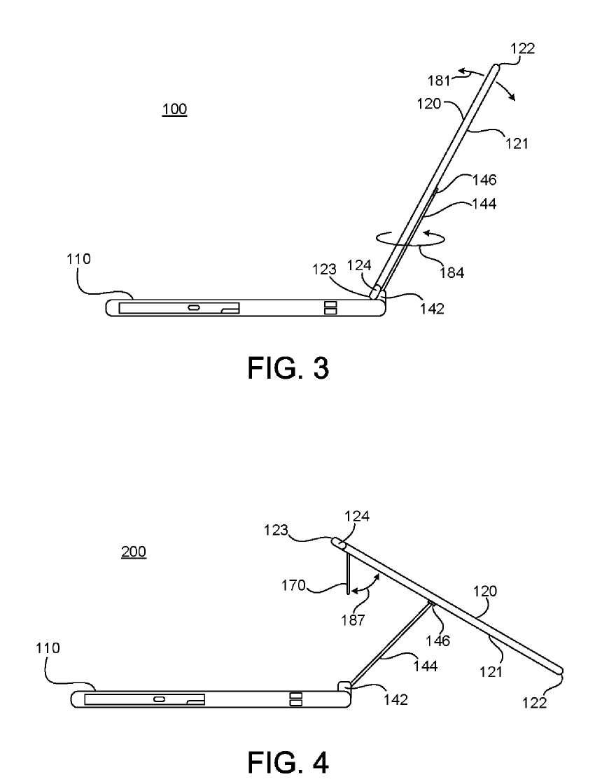

FIG. 3 is a side elevational view of the movable laptop computer display system 100, in accordance with an embodiment of the invention. The movable laptop computer display system 100 includes the computer 110, the hinge 142, the member 144, the hinge 146, and the display 124. The display 124 includes a top 122, bottom 123, front 120 and rear 121 portions.

In one embodiment, the computer 110 is coupled to the display 124 by the member 144. The member 144 is coupled to the computer 110 by the hinge 142 and the member 144 is coupled to the display 124 by the hinge 146. The hinge 142 is configured to permit the display 124 to swivel 183, 184 and fold 182 relative to the computer 110. Although the hinge 146 is configured to permit tilting motion 181 as described in relation to FIG. 1, FIG. 3 illustrates the display 124 being removeably coupled against the member 144 to optionally disable this motion. Accordingly, the member 144 is shown partially imbedded within the cavity (not shown) on the rear portion 121 of the display 124; however, the member 144 may be more, less, or not imbedded. In this regard, the display 124 may swivel 183, 184 to a position where the front portion 120 of the display 124 is facing away from the computer 110. Further, the display 124 may fold 182 upon the computer 110 with either the rear portion 121 or the front portion 120 facing away from the computer 110. Alternatively, the display 124 may be decoupled from the member 144 and partially or completely tilt 181 relative to the member 144.

FIG. 4 is side elevational view of a movable laptop computer display system 200, in accordance with an embodiment of the invention. The laptop computer display system 200 includes various embodiments as described in relation to FIGS. 1-3. As illustrated here, the computer 110 is coupled to the display 124, having a top 122, a bottom 123, a front 120, and a rear 121 portions, by the member 144. The member 144 is coupled to the computer 110 by the hinge 142 and the member 144 is coupled to the display 124 by the hinge 146. The hinge 142 permits the display 124 to swivel 183 and fold 182 relative to the computer 110. The hinge 146 permits the display to tilt 181 relative to the member 144. As illustrated here, the display 124 is folded 182 away from the computer 110 and the display 124 is tilted 181 whereby the top portion 122 of the display 124 is below the bottom portion 123 of the display 124. Alternatively, a similar position could have been achieved by swiveling 183 the display 124 so the front portion 120 faced away from the computer 110, folding 182 the display 124 away from the computer 110, and titling 181 the display.

In one particular embodiment, the display 124 includes a miniature display screen 170 so that an image is displayable on both the display 124 and the miniature display screen 170. The miniature display screen 170 may be foldable 187 or fixably coupled to the display 124 and the miniature display screen 170 may be located at various places on the display 124 or on the computer 110.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A system, the system comprising:
a display, the display having a first hinge;
a computer, the computer having a second hinge;
a member, the member having a first and second end, the first end being coupled to the first hinge and the second end being coupled to the second hinge.

2. The system of claim 1 wherein the first hinge is configured to permit the display to tilt relative to the computer.

3. The system of claim 2 wherein the second hinge is configured to permit the display to fold and swivel relative to the computer.

4. The system of claim 3 wherein the display has a back portion and wherein the first hinge is centrally coupled to the back portion.

5. The system of claim 4 wherein the back portion includes a channel, the channel having a cavity, wherein the member is configurable to be removeably imbedded within the cavity.

6. The system of claim 5 further comprising a miniature display, the miniature display being coupled to the back portion.

7. A system, the system comprising:
a member, the member having a first end and a second end, the first end being coupled to a first hinge, and the second end being coupled to a second hinge,
wherein the first hinge is configurable to being coupled to a display and the second hinge is configurable to being coupled to a computer.

8. The system of claim 7 wherein the first hinge is configurable to permit the display to tilt relative to the computer.

9. The system of claim 8 wherein the second hinge is configurable to permit the display to fold and swivel relative to the computer.

10. The system of claim 9 wherein the first hinge is configurable to being centrally coupled to the display.

11. The system of claim 10 wherein the member is configurable to being removeably imbedded within a cavity on the display.

12. A method, the method comprising the steps of:
folding a display relative to a computer;
swiveling a display relative to a computer; and
tilting a display relative to a computer.

13. The method of claim 12, further comprising the step of viewing a second display coupled to the computer.
